(19) United States
(12) Patent Application Publication
(10) Pub. No.: US 2024/0017470 A1
(43) Pub. Date: Jan. 18, 2024

(54) APPARATUS AND METHOD FOR FORMING PLASTIC PREFORMS INTO PLASTIC CONTAINERS, HAVING A MOLD CARRIER HOLDER WITH CARRYING FUNCTION

(71) Applicant: KRONES AG, Neutraubling (DE)

(72) Inventors: Daniel THEEN, Lappersdorf (DE); Florian GELTINGER, Donaustauf (DE); Florian GERNGROSS, Regensburg (DE); Waldemar SUPPES, Nittendorf (DE); Juergen SOELLNER, Beratzhausen (DE); Christian WITTMANN, Hemau (DE)

(21) Appl. No.: 18/222,911

(22) Filed: Jul. 17, 2023

(30) Foreign Application Priority Data
Jul. 15, 2022 (DE) 10 2022 117 729.7

(51) Int. Cl. B29C 49/46; B29C 49/08

(52) U.S. Cl. CPC B29C 49/46; B29C 49/086; B29C 2049/4697

(57) ABSTRACT

An apparatus for forming plastic preforms into plastic containers includes a rotatable transport carrier on which a plurality of forming stations is arranged, and forming stations each having blow molding devices within which the plastic preforms can be formed into the plastic containers by applying a flowable medium. The forming stations each have stretching devices having at least one stretching rod which can be moved in the longitudinal direction of the plastic preforms and introduced into the plastic preforms. The apparatus also has a clean room within which the plastic preforms are expanded to form the plastic containers. The stretching devices and the forming stations are each arranged on a mold carrier holder and are held thereby, so that the mold carrier holder is designed as a carrying device of the apparatus and walls of the clean room to delimit the apparatus from a non-sterile environment.

### BACKGROUND OF THE INVENTION

The present invention relates to an apparatus and a method for forming plastic preforms into plastic containers. Such apparatuses and methods have long been known from the prior art. The plastic preforms are usually formed into the plastic containers within a forming station and more precisely within a blow molding apparatus by applying a flowable medium. The blow molding devices usually have two blow molding side parts and a bottom part, which together form a hollow space that corresponds to a negative contour of the finished plastic container. Furthermore, so-called blow molding machines are known from the prior art which, during the blowing process, stretch the plastic preforms also in their longitudinal direction and, for this purpose, have a stretching unit with a stretching rod. They are, in particular, so-called stretch blow molding machines.

A plurality of forming stations is arranged on a movable and, in particular, rotatable transport carrier, in particular a blowing wheel. In the applicant's internal prior art, this blowing wheel is of very solid design and carries both the forming stations and the stretching units. At the same time, the blowing wheel is the rotating part within the clean room, so that a very large mass must be set in rotation.

The blowing wheel known from the applicant's internal prior art is therefore very heavy and difficult to manufacture, wherein moreover the assembly of the forming stations on the blowing wheel is also complicated since the latter must be lifted onto the blowing wheel from the front.

In recent times, apparatuses and methods have become known in which the forming of the plastic preforms into the plastic containers takes place within a clean room. In this way, it is possible, for example, to perform the entire forming process already under sterile conditions and therefore, the manufactured plastic containers need not be sterilized again or need to be sterilized only with reduced effort.

With the apparatuses, known from the applicant's prior art, for forming plastic preforms into plastic containers, a large part of the components which move in the blowing station is arranged outside the clean room. They include, for example, locking rollers and the bottom lift control or also couplings for hoses or lines. In that case, the mechanical system is separated from the clean room in each case by two bellows.

These bellows are disadvantageous, since they wear very quickly and have to be replaced accordingly. Moreover, the mounting positions of the bellows which are located under the insulator or clean room are not easy to access.

The object of the present invention is therefore to provide an apparatus and a method which eliminate the disadvantages known from the prior art. According to the invention, this object is achieved by the subject matters of the independent claims. Advantageous embodiments and developments are the subject matter of the dependent claims.

### SUMMARY OF THE INVENTION

The invention is therefore directed to an apparatus for forming plastic preforms into plastic containers, having a transport device which transports the plastic preforms to be formed along a predetermined transport path, wherein the transport device has a rotatable transport carrier on which a plurality of forming stations is arranged, wherein said forming stations each have blow molding devices within which the plastic preforms can be formed into the plastic containers by applying a flowable medium, and the forming stations each have application devices in order to apply the flowable medium to the plastic preforms, wherein the forming stations each have stretching devices for stretching the plastic preforms in their longitudinal direction, and these stretching devices each having at least one stretching rod which can be moved in the longitudinal direction of the plastic preforms and introduced into the plastic preforms, and wherein the apparatus has a clean room which is delimited by several walls and within which the plastic preforms are expanded to form the plastic containers.

According to the invention, the stretching devices and/or the forming stations are arranged on a mold carrier holder and are held thereby, so that the mold carrier holder is designed as a carrying device of the apparatus and the walls of the clean room are only suitable and intended to delimit the apparatus from an non-sterile environment.

Accordingly, it is proposed according to the invention to design the walls of the clean room as non-carrying devices which only, preferably exclusively, serve to delimit the apparatus from the non-sterile environment, and to arrange the forming station and the stretching unit on a mold carrier which is designed as a carrying device. Accordingly, the walls of the clean room preferably have (only or exclusively) a delimiting function.

An embodiment as a non-carrying device is understood to mean, in particular, that the walls of the clean room are neither suitable nor intended for carrying components of the apparatus, such as drives, forming stations and the like.

Thus, the walls of the clean room can be manufactured, for example, in a material thickness and/or a material which does not allow for a carrying and/or supporting function.

In the apparatus, a simple transport carrier or simple blowing wheel is preferably used, on which a lower part of the clean room or insulator with a sealing device, for example a water lock, is preferably placed. It, or the walls of this clean room, then mainly consist of a thin sheet metal and do not themselves have a carrying function.

The forming stations are subsequently mounted on the walls of the clean room with or via a mold carrier holder. The forming stations are therefore preferably arranged for the most part within the clean room and preferably consist of H₂O₂-stable material, so that they are not affected by the sterilization medium.

In order to close the clean room, a cover is preferably arranged on the lower part of the clean room, wherein this cover preferably also consists of a thin sheet metal and has no carrying function. The cover is preferably not connected in a form-fitting manner to the parts of the station.

The clean room is preferably closed with the cover, and this cover is arranged on at least one carrying element within the clean room by means of fastening devices, and preferably on several carrying elements within the clean room.

These carrying elements are preferably selected from a group of carrying elements which are stretching devices, mold carrier holders, a rear insulator wall, columns which are arranged on the transport carrier and the like.

The apparatus therefore preferably has one and particularly preferably a plurality of fastening columns in order to fasten the cover to the clean room walls and to support it. The fastening columns are preferably arranged on the transport carrier or blowing wheel and preferably outside the clean room. Particularly preferably, the fastening columns are arranged centrally on the transport carrier. In addition, it is also conceivable for the cover to be additionally supported via the mold carrier and/or the stretching devices and/or to be fastened also to other system parts and/or assemblies.

This structure enables a significantly simpler assembly, since the forming stations can be lifted onto the blowing wheel in an already pre-assembled state. In addition, the blowing wheel with insulator is easier to manufacture and considerably lighter.

The apparatus for forming plastic preforms into plastic containers is preferably a blow molding machine. The rotatable transport carrier mentioned above is preferably a blowing wheel. The blow molding devices are preferably designed in multiple parts and have two blow mold halves and a bottom mold. These blow mold halves are preferably detachably arranged on a mold carrier shell or on the blow mold carriers. The blow mold carriers are pivotable relative to one another in order to open and close the blow molding devices. In addition, the blow mold carrier has locking mechanisms in order to lock the mold halves against each other during the blowing process.

In order to apply compressed air to the plastic preforms, the apparatus preferably has a blow nozzle which can be applied to an opening of the plastic preforms in order to apply blowing air to the plastic preforms or to expand them by means of blowing air. In addition, a valve arrangement is preferably also provided which controls the supply of the blowing air to the plastic preforms.

The blow molding devices are preferably transported within the clean room, wherein the clean room is preferably delimited by several walls.

In a preferred embodiment, the walls of the clean room are designed as a non-carrying device and, as mentioned above, are therefore neither suitable nor intended to carry components of the apparatus.

In a further preferred embodiment, the clean room is delimited by at least one standing wall and a wall moving relative to this standing wall. Accordingly, the apparatus preferably has a stationary part and a rotatable part. The transport carrier is preferably a component of the rotatable part of the apparatus. The cover is preferably also a component of the rotatable or rotating part of the apparatus.

The at least one circumferential channel mentioned above is preferably a component of the stationary part of the apparatus. The apparatus preferably has a circumferential wall immersed into a liquid medium, for example water, located in the channel. This wall is preferably part of the rotating part of the apparatus.

The circumferential channel mentioned above is preferably designed to be annular. Particularly preferably, the clean room has a toroidal shape. Particularly preferably, the clean room is delimited by said annular channel and preferably a further correspondingly annular channel.

In this case, for example, the transport carrier on which the blow molding devices are arranged can already have or form one of these walls and in particular the moving wall. The clean room separates the blow molding devices in particular from a non-sterile environment.

In a preferred embodiment, the apparatus has a sealing device in order to seal the clean room from an non-sterile environment, and this sealing device has at least one circumferential channel that can be filled with a liquid. Particularly preferably, the sealing device has a circumferential wall which projects into the circumferential channel, wherein this wall is the moving wall and is preferably designed to be rotatable.

This circumferential wall projecting into the channel is preferably at least one blade immersed into the flowable medium, thus separating a non-sterile region from the sterile region. It is thus proposed to use a so-called water lock for sealing the clean room.

The circumferential wall of the sealing device is preferably designed to be rotatable relative to the channel. Preferably, the rotational movement of this wall is coupled to the rotational movement of the transport carrier. This wall is therefore preferably a circulating blade which forms part of the water lock or of the hydraulic seal. Particularly preferably, this wall is immersed into the liquid located in the channel. Conversely, it would also be conceivable for the channel to be rotatable and the circumferential wall to be designed to be stationary.

The circumferential wall of the sealing device preferably subdivides the circumferential channel into a radially inner channel section and a radially outer channel section, wherein the blade is preferably immersed into the liquid in a region between the inner channel section and the outer channel section.

In a preferred embodiment, the walls of the clean room are made of a metal sheet selected from a group of metal sheets containing aluminum sheet, steel sheet, stainless steel sheet and the like and/or wherein the walls have a material thickness which is less than 50 mm, preferably less than 40 mm, particularly preferably less than 30 mm and particularly preferably less than 20 mm. The walls of the clean room advantageously have a material thickness that is greater than 1 mm, preferably greater than 2 mm and preferably greater than 3 mm. The material thickness of the walls is particularly preferably between 3 mm and 20 mm. The walls are preferably made of a material with steel number 1.4301. These materials and material thicknesses are advantageous in order to realize an as lightweight design as possible of the clean room.

In a preferred embodiment, the mold carrier holder is arranged within the clean room and is particularly preferably arranged completely within the clean room. The mold carrier holder is preferably arranged on or attached to the transport carrier.

In a further preferred embodiment, the mold carrier holder is made of a material selected from a group of materials including cast aluminum, cast steel and the like. The mold carrier holder preferably consists of a material that has a higher strength than the walls of the clean room. Preferably, the mold carrier holder is not manufactured from cast steel, but from cast aluminum, in order to make it lighter and to save weight. The mold carrier holder preferably affixes the lower water lock.

In a preferred embodiment, the stretching device is arranged at least partially outside the clean room. The largest part of the stretching device is preferably arranged outside the clean room. The stretching device preferably projects outwards or into the clean room through an opening in the cover.

In an advantageous embodiment, a locking device, in particular a locking roller and a locking cam, are arranged within the clean room for locking the blow molding device. The locking device serves for locking the blow mold side parts and the bottom part, in particular during the forming process. Furthermore, a bottom lifting apparatus and bottom lifting control for moving a bottom part of the blow molding device in the longitudinal direction are also advantageously arranged within the clean room. Arranging movable parts within the clean room is advantageous since, as a result, bellows, which are necessary for sealing parts protruding into the clean room, in particular movable parts, can be dispensed with, which also simplifies the assembly process.

In a preferred embodiment, the forming stations and/or the locking apparatus and/or the bottom lifting apparatus are made of an H₂O₂-resistant material. This is advantageous since the components are thus not damaged when the clean room is applied with a (sterilization) medium or parts within the clean room are also sterilized.

The present invention is further directed to a method for operating an apparatus for forming plastic preforms into plastic containers, having a transport apparatus which transports the plastic preforms to be formed along a predetermined transport path, wherein the transport apparatus has a rotatable transport carrier on which a plurality of forming stations is arranged, wherein said forming stations each have blow molding devices within which the plastic preforms are formed into the plastic containers by applying a flowable medium and the forming stations each have application devices which apply the flowable medium to the plastic preforms, wherein the forming stations each have stretching devices which stretch the plastic preforms in their longitudinal direction, and these stretching devices each having at least one stretching rod which can be moved in the longitudinal direction of the plastic preforms and are introduced into the plastic preforms, and wherein a clean room is provided which is delimited by several walls and within which the plastic preforms are expanded to form the plastic containers.

According to the invention, the stretching devices and the forming stations are each arranged on a mold carrier holder and are held thereby, so that the mold carrier holder is designed as a carrying device of the apparatus and the walls of the clean room are only suitable and intended to delimit the apparatus from an non-sterile environment.

Accordingly, it is proposed also from a method side to design the walls of the clean room as non-carrying devices which only, preferably exclusively, serve to delimit the apparatus from the non-sterile environment, and to arrange the forming station and the stretching unit on a mold carrier which is designed as a carrying device. Accordingly, the walls of the clean room preferably have (only or exclusively) a delimiting function.

The apparatus described above is designed and provided, in particular, to carry out this described method, i.e. that all features designed for the apparatus described above are also disclosed for the method described here, and vice versa.

### BRIEF DESCRIPTION OF THE DRAWING

Further advantages and embodiments emerge from the accompanying drawing.

In the drawing:

FIG. 1 shows a detailed view of the forming station according to the invention.

### DETAILED DESCRIPTION OF THE INVENTION

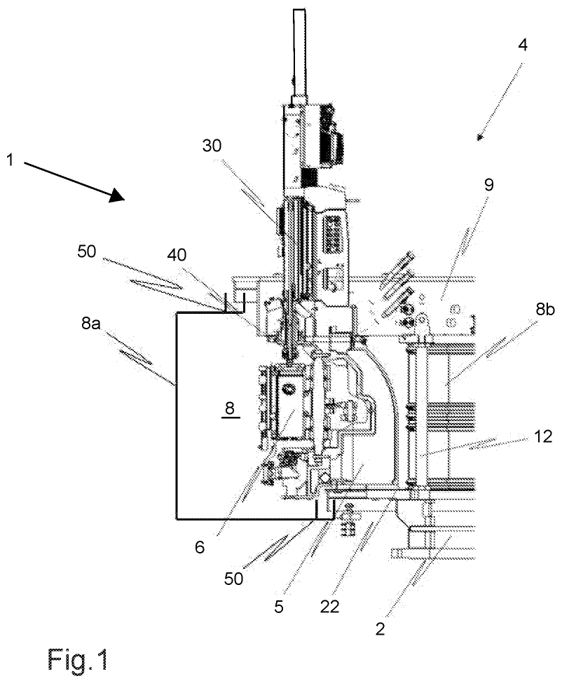

FIG. 1 shows a schematic view of an apparatus 1 according to the invention for forming plastic preforms (not shown) into plastic containers (not shown). This apparatus is preferably a forming station 4. Forming is carried out within a blow molding device 6, which is arranged on a mold carrier holder 5. This mold carrier holder 5 is preferably designed as a carrying device and carries also the stretching devices 30 in addition to the blow molding devices 6.

The mold carrier holders 5 are arranged on the transport carrier 22, which transports the blow molding devices 6 within a clean room 8. The clean room 8 has at least one standing wall 8a and a moving wall 8b, which are sealed relative to each other by means of a sealing device 50. These walls 8a, 8b of the clean room 8 are preferably designed as non-carrying devices.

The clean room 8 is also delimited by a cover 9. The cover 9 is fastened to the transport carrier 22 by means of several (shown is only one) fastening devices 12 and—like the walls of the clean room—is preferably designed as a non-carrying device.

The reference number 40 designates the application device which applies a flowable medium to the plastic preforms (not visible) in the blow molding device 6 for expansion thereof.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a FIGURE can be advantageous even without the adoption of further features from this FIGURE. Furthermore, the person skilled in the art will recognize that advantages can also result from a combination of several features shown in individual or in different figures.

### LIST OF REFERENCE SIGNS

1 apparatus
2 transport device
4 forming station
5 mold carrier holder
6 blow molding device
8 clean room
8a standing wall
8b moving wall
9 cover
12 fastening device
22 transport carrier
30 stretching device
40 application device
50 sealing device

1. An apparatus for forming plastic preforms into plastic containers, having a transport device which transports the plastic preforms to be formed along a predetermined transport path, wherein the transport device has a rotatable transport carrier on which a plurality of forming stations is arranged, wherein said forming stations each have blow molding devices within which the plastic preforms can be formed into the plastic containers by applying a flowable medium, and the forming stations each have application devices in order to apply the flowable medium to the plastic preforms, wherein the forming stations each have stretching devices for stretching the plastic preforms in their longitudinal direction, and these stretching devices each having at least one stretching rod which can be moved in the longitudinal direction of the plastic preforms and introduced into the plastic preforms, and wherein the apparatus has a clean room which is delimited by several walls and within which the plastic preforms are expanded to form the plastic containers, wherein the stretching devices and/or the forming stations are arranged on a mold carrier holder and are held thereby, so that the mold carrier holder is designed as a carrying apparatus of the apparatus and the walls of the clean room are only suitable and intended to delimit the device from an non-sterile environment.

2. The apparatus according to claim 1, wherein the walls of the clean room are designed as a non-carrying device.

3. The apparatus according to claim 1,
wherein
the clean room is delimited by at least one standing wall and a wall moving relative to this standing wall.

4. The apparatus according to claim 1,
wherein
the apparatus has a sealing device in order to seal the clean room from an non-sterile environment, and this sealing device has at least one circumferential channel that can be filled with a liquid.

5. The apparatus according to claim 4, wherein the sealing device has a circumferential wall which projects into the circumferential channel, wherein this wall is the moving wall.

6. The apparatus according to claim 1,
wherein
the walls are made of a metal sheet selected from a group of metal sheets consisting of aluminum sheet, steel sheet, stainless steel sheet, and/or the walls have a material thickness that is less than 50 mm.

7. The apparatus according to claim 1,
wherein
the mold carrier holder is arranged within the clean room.

8. The apparatus according to claim 1,
wherein
the mold carrier holder is made of a material selected from a group of materials consisting of cast aluminum and cast steel.

9. The apparatus according to claim 1,
wherein the stretching device is arranged at least partially outside the clean room.

10. The apparatus according to claim 1,
wherein
a locking device for locking the blow molding device is arranged within the clean room.

11. The apparatus according to claim 1,
wherein
a bottom lifting device and bottom lifting control for moving a bottom part of the blow molding device in the longitudinal direction is arranged within the clean room.

12. The apparatus according to claim 1,
wherein
the forming stations and/or the locking device and/or the bottom lifting device are made of an H₂O₂-resistant material.

13. A method for operating an apparatus for forming plastic preforms into plastic containers, having a transport device which transports the plastic preforms to be formed along a predetermined transport path, wherein the transport device has a rotatable transport carrier on which a plurality of forming stations is arranged, wherein said forming stations each have blow molding devices within which the plastic preforms are formed into the plastic containers by applying a flowable medium and the forming stations each have application devices which apply the flowable medium to the plastic preforms, wherein the forming stations each have stretching devices which stretch the plastic preforms in their longitudinal direction, and these stretching devices each having at least one stretching rod which can be moved in the longitudinal direction of the plastic preforms and are introduced into the plastic preforms, and wherein a clean room is provided which is delimited by several walls and within which the plastic preforms are expanded to form the plastic containers, wherein
the stretching devices and/or the forming stations are each arranged on a mold carrier holder and are held thereby, so that the mold carrier holder is designed as a carrying device of the apparatus and the walls of the clean room are only suitable and intended to delimit the apparatus from an non-sterile environment.
